(19) United States
(12) Patent Application Publication
(10) Pub. No.: US 2026/0288371 A1
(43) Pub. Date: Sep. 24, 2026

(54) MEMORY SYSTEM, CONTROL DEVICE, AND CONTROL METHOD

(71) Applicant: Kioxia Corporation, Tokyo (JP)

(72) Inventors: Shohei Onishi, Ota Tokyo (JP); Akifumi Fukuda, Yokohama Kanagawa (JP)

(73) Assignee: Kioxia Corporation, Tokyo (JP)

(21) Appl. No.: 19/318,461

(22) Filed: Sep. 4, 2025

(30) Foreign Application Priority Data
Mar. 24, 2025 (JP) 2025-047824

(51) Int. Cl. G06F 3/06

(52) U.S. Cl. CPC G06F 3/0656; G06F 3/0604; G06F 3/0679

(57) ABSTRACT

According to one embodiment, a memory system includes one or more memories and a controller. The controller is capable of communicating with a host, and is configured to control the memory. The controller includes a cache for temporarily storing data read from the memory. The controller reads, after receiving a prefetch request from the host, prefetch target data from the memory and store the read data in the cache, manages first information related to whether or not the prefetch is effective for each data read from the memory in response to a demand access request from the host, and performs first processing related to data layout optimization of the data read from the memory based on the first information.

### CROSS-REFERENCE TO RELATED APPLICATIONS

This application is based upon and claims the benefit of priority from Japanese Patent Application No. 2025-047824, filed Mar. 24, 2025, the entire contents of which are incorporated herein by reference.

### FIELD

Embodiments described herein relate generally to a memory system, a control device, and a control method.

### BACKGROUND

In recent years, hierarchical memory systems that hierarchically combine a plurality of memory devices with different data transfer speeds have been widely used.

Hierarchical memory systems place data with high access frequency in memory devices with fast data transfer speeds and data with low access frequency in memory devices with slow data transfer speeds. Data with high access frequency is referred to as hot data or hot, etc. On the other hand, data with low access frequency is referred to as cold data or cold, etc.

Hierarchical memory systems are required to minimize the processing costs for optimizing data placement, such as moving data between memory devices with fast data transfer speeds and memory devices with slow data transfer speeds.

### BRIEF DESCRIPTION OF THE DRAWINGS

FIG. 1 is a diagram showing an example of a configuration of a memory module of a first embodiment.

FIG. 2 is a diagram showing an example of cache management information managed in the memory module of the first embodiment.

FIG. 3 is a diagram showing an example of access monitoring information managed in the memory module of the first embodiment.

FIG. 4 is a diagram showing a first comparative example for the memory system of the first embodiment.

FIG. 5 is a diagram showing a second comparative example for the memory system of the first embodiment.

FIG. 6 is a first diagram showing a method for determining whether or not it is a page for which prefetching is effective in the memory system of the first embodiment.

FIG. 7 is a second diagram showing a method for determining whether or not it is a page for which prefetching is effective in the memory system of the first embodiment.

FIG. 8 is a flowchart showing a flow of memory access within the memory system of the first embodiment.

FIG. 9 is a flowchart showing a procedure for updating access monitoring information in the memory system of the first embodiment.

FIG. 10 is a flowchart showing a method for determining a state of each unit in the memory system of the first embodiment.

FIG. 11 is a flowchart showing a timing for executing particular processing related to data placement optimization in the memory system of the first embodiment.

FIG. 12 is a diagram showing an example of a configuration of a memory module of a second embodiment.

FIG. 13 is a diagram showing a method for determining whether or not it is a page for which prefetching is effective in the memory system of the second embodiment.

FIG. 14 is a diagram showing an example of cache management information managed in the memory module of the second embodiment.

FIG. 15 is a diagram showing an example of access monitoring information managed in the memory module of the second embodiment.

FIG. 16 is a flowchart showing a flow of memory access within the memory system of the second embodiment.

FIG. 17 is a flowchart showing a procedure for updating access monitoring information in the memory system of the second embodiment.

FIG. 18 is a flowchart showing a method for determining a state of each unit in the memory system of the second embodiment.

FIG. 19 is a flowchart showing a timing for executing particular processing related to data placement optimization in the memory system of the second embodiment.

FIG. 20 is a diagram showing an example of a configuration of a memory module of a third embodiment.

FIG. 21 is a diagram showing an example of access monitoring information managed in the memory module of the third embodiment.

FIG. 22 is a flowchart showing a flow of memory access within the memory system of the third embodiment.

FIG. 23 is a flowchart showing a procedure for updating access monitoring information in the memory system of the third embodiment.

FIG. 24 is a flowchart showing a method for determining a state of each unit in the memory system of the third embodiment.

FIG. 25 is a diagram showing an example of a configuration of a memory module of a fourth embodiment.

FIG. 26 is a diagram showing an example of cache management information managed in the memory module of the fourth embodiment.

FIG. 27 is a flowchart showing a flow of memory access within the memory system of the fourth embodiment.

FIG. 28 is a flowchart showing a method for determining a state of each unit in the memory system of the fourth embodiment.

FIG. 29 is a diagram showing an example of a configuration of a memory module of a fifth embodiment.

FIG. 30 is a flowchart showing a method for determining a state of each unit in the memory system of the fifth embodiment.

### DETAILED DESCRIPTION

In general, according to one embodiment, a memory system includes one or more memories and a controller. The controller is capable of communicating with a host, and is configured to control the memory. The controller includes a cache for temporarily storing data read from the memory. The controller reads, after receiving a prefetch request from the host, prefetch target data from the memory and store the read data in the cache, manages first information related to whether or not the prefetch is effective for each data read from the memory in response to a demand access request from the host, and performs first processing related to data layout optimization of the data read from the memory based on the first information.

The following describes the embodiments with reference to the drawings.

### First Embodiment

First, a first embodiment will be described.

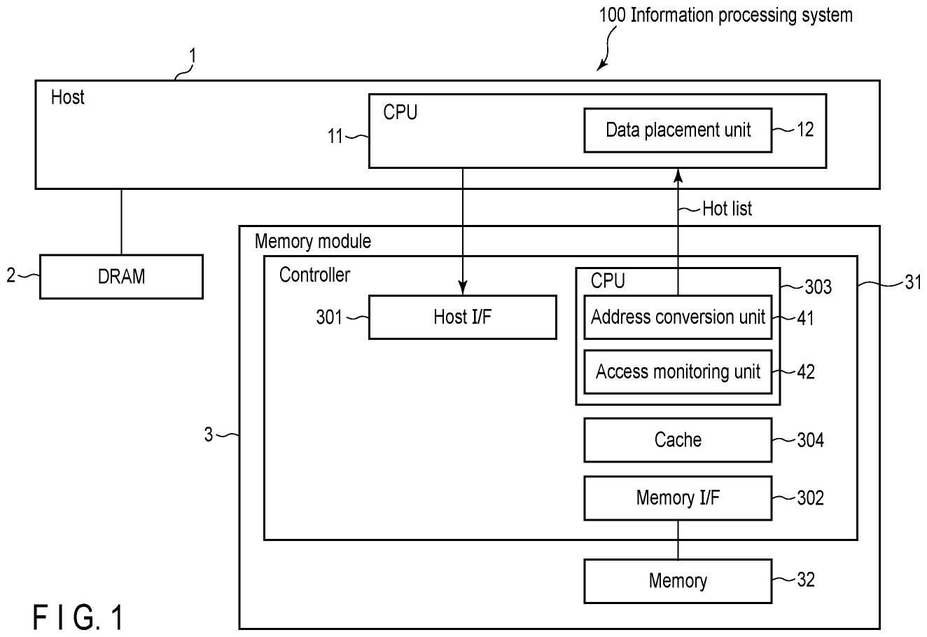

FIG. 1 is a diagram showing an example of a configuration of a memory module (memory system) 3 of the first embodiment. FIG. 1 shows an example where the memory module 3 of the first embodiment is connected to a host 1 together with a dynamic RAM (random access memory) (DRAM) 2 to configure an information processing system 100.

The host 1 is an information processing device such as a server. The host 1 has a central processing unit (CPU) 11 that executes an operating system (OS) and application programs running under the OS.

The OS executed by the CPU 11 maps a memory area of the DRAM 2 and a memory area of the memory module 3 (a memory area of a memory 32 described later) into a virtual address space, thereby enabling the CPU 11 to access the DRAM 2 and the memory module 3 seamlessly.

The DRAM 2 is a memory device that has the following characteristics compared with the memory module 3: (1) a faster data transfer speed; and (2) a higher cost. In other words, the memory module 3 is a memory device that has the following characteristics compared with the DRAM 2: (1) a slower data transfer speed; and (2) a lower cost. In addition, in most cases, the DRAM 2 has a smaller storage capacity than the memory module 3. The host 1 combines the DRAM 2 and the memory module 3, which have these characteristics, to form a hierarchical memory system. To optimize data placement in the hierarchical memory system, the CPU 11 collaborates with software and hardware to realize a data placement unit 12. The data placement unit 12 receives a hot list from an access monitoring unit 42 described below of the memory module 3 and performs processing of moving data listed in the hot list from the memory module 3 to the DRAM 2. The hot list is data containing a list of hot data within data stored in the memory 32. The movement of data is performed in units obtained by dividing the virtual address space into predetermined sizes. This unit is referred to as a page. That is, the hot list includes a list of pages.

The memory module 3 includes a controller 31 and a memory 32. The controller 31 is a control device that integrally controls the memory module 3. The controller 31 controls, for example, processing of writing data to the memory 32 and processing of reading data from the memory 32. The controller 31 is capable of communicating with the host 1. The memory 32 is a nonvolatile memory device, such as NAND flash memory. The memory module 3 is also referred to as a memory system or a storage device.

The controller 31 includes a host interface (I/F) 301, a memory interface (I/F) 302, a CPU 303, and a cache 304. The CPU 303 collaborates with software and hardware to realize an address conversion unit 41 and the access monitoring unit 42.

The host I/F 301 communicates with the host 1 using a protocol that is compliant with, for example, the compute express link (CXL)™ standard.

The memory I/F 302 transmits and receives data to and from the memory 32 using an interface that is compliant with, for example, the toggle double data rate (DDR) standard.

The address conversion unit 41 converts a logical address specified in a prefetch request or a demand access request received from the host 1 into a physical address indicating a physical location within the memory 32. The prefetch request is a command requesting that data stored in the memory 32 be prefetched into the cache 304. The demand access request is a command requesting that data stored in the memory 32 be output to a requesting source (host 1) (read processing) or that data input from the requesting source (host 1) be stored in the memory 32 (write processing). The demand access request is a read request for data stored in the memory 32 or a write request for data to be stored in the memory 32.

The demand access request does not necessarily require the prefetch request to be performed as a preprocessing step. When the demand access request is received, if target data exists in the cache 304, the target data is read from the cache 304 and output to the host 1. On the other hand, in a case where the target data does not exist in the cache 304, the target data is read from the memory 32, stored in the cache 304, and output to the host 1. An event where the target data of the demand access request exists in the cache 304 is referred to as a cache hit or a hit, etc. An event where the target data of the demand access request does not exist in the cache 304 is referred to as a cache miss or a miss, etc. When data exists in the cache 304, it means that the data is stored (memorized) in the cache 304.

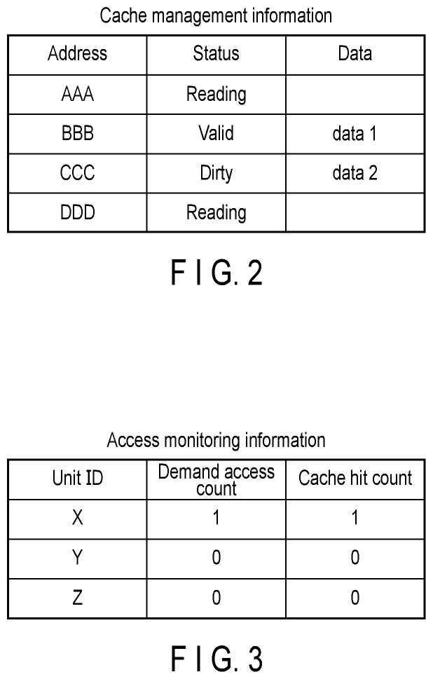

The cache 304 is configured using, for example, a memory area of a static RAM (SRAM) built into the controller 31. The controller 31 manages cache management information shown in FIG. 2 with respect to the cache 304.

As shown in FIG. 2, the cache management information has a plurality of entries and stores, for example, an address, a status, and data for each entry.

The address may be a logical address specified by the prefetch request or the demand access request received from the host 1, or a physical address indicating a physical location of the data stored in the cache 304 in the memory 32.

The status indicates a state of data. “Reading” indicates that the data is being read from the memory 32. For example, in a case where the state of the target data of the demand access request is “Reading”, this is essentially a cache miss. “Valid” indicates that the data can be read from the cache 304. That is, in a case where the state of the target data is “Valid,” it is a cache hit. “Dirty” indicates that the data has been updated in the cache 304 but the update has not yet been reflected in the memory 32. In a case where the state of the target data is “Dirty,” it is also a cache hit.

In a case where the data has a status of “Valid”, it is actual data read from the memory 32. In a case where the data has a status of “Dirty”, it is actual data to be stored in the memory 32.

Returning to FIG. 1, the description of the components of the memory module 3 will continue.

The access monitoring unit 42 monitors access from the host 1 to data stored in the memory 32. The access monitoring unit 42 manages the monitoring results as access monitoring information. FIG. 3 shows an example of the access monitoring information.

As shown in FIG. 3, the access monitoring information stores, for example, a unit ID, a demand access count, and a cache hit count for each entry.

The unit ID is an identifier uniquely determined from the logical address. The unit ID is associated one-to-one with pages obtained by dividing the logical address space into predetermined sizes.

The demand access count is the number of demand access requests for a page corresponding to the unit ID.

The cache hit count is the number of cache hits in response to the demand access request.

Among items of the access monitoring information, the cache hit count is a new item unique to the memory module 3.

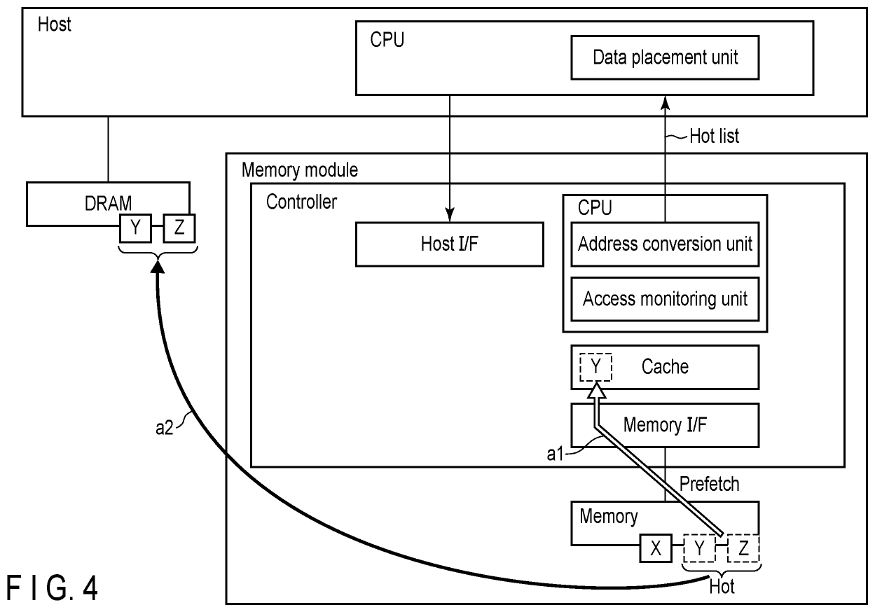

Here, referring to FIG. 4, a first comparative example for the memory module 3 of the first embodiment will be described.

FIG. 4 shows an example where three data items, “X,” “Y,” and “Z,” exist in a memory of a memory module, with “X” being cold and “Y” and “Z” being hot. Additionally, it is shown that “Y” of the hot “Y” and “Z” is stored in a cache of a controller by a prefetch request (a1).

The CXL standard defines a functional unit referred to as a CXL hotness monitoring unit (CHMU). In order to reduce monitoring costs of a host, the CHMU has a function of detecting hot data on the memory module side and providing the host with a hot list, which is data including a list of hot data. An access monitoring unit of the first comparative example shown in FIG. 4 may be this CHMU.

A data placement unit of the host optimizes data placement by, for example, moving hot data from the memory of the memory module to a DRAM, based on the hot list received from the memory module. In the first comparative example shown in FIG. 4, the data placement unit of the host moves “Y” and “Z” from the memory of the memory module to the DRAM (a2).

As mentioned earlier, “Y” is prefetched into the cache of the controller. If “Y” can hide latency of the memory module (which is equal to or greater than latency of the DRAM) through prefetching, i.e., if the prefetching of “Y” is effective, then moving “Y” to the DRAM by the host should be unnecessary.

Unnecessary data movement increases the consumption amount of the DRAM memory area and also increases the load on both the host and the memory module. Additionally, unnecessary data movement may affect the data stored in memory cells of the memory.

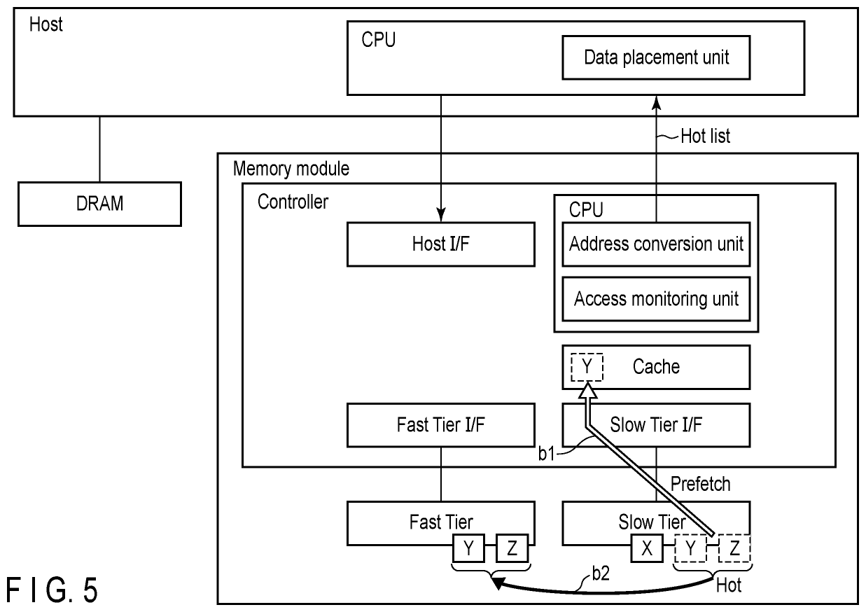

FIG. 5 is a diagram showing a second comparative example for the memory module 3 of the first embodiment.

A memory module shown in FIG. 5 has a Fast-Tier, which is a memory device with a fast data transfer speed, and a Slow-Tier, which is a memory device with a slow data transfer speed. For example, the Fast-Tier is a DRAM, and the Slow-Tier is NAND flash memory. A DRAM mounted in the memory module as the Fast-Tier has a greater latency than a DRAM directly connected to a host because a controller is interposed between the DRAM and the host.

In the case of this memory module, it is preferable to place hot data in the Fast-Tier and cold data in the Slow-Tier.

Here, as in the first comparative example shown in FIG. 4, a case is considered where three data items “X,” “Y,” and “Z” exist in the Slow-Tier, with “X” being cold and “Y” and “Z” being hot, and “Y” is stored in a cache of the controller by a prefetch request (b1).

In this case, a data placement unit of the host that receives a hot list including “Y” and “Z” from the memory module may optimize data placement (b2) by moving “Y” and “Z” from the Slow-Tier to the Fast-Tier. However, if “Y” can hide latency of the Slow-Tier (which is equal to or greater than latency of the Fast-Tier) through prefetching, i.e., if the prefetching of “Y” is effective, then moving “Y” to the Fast-Tier by the host should be unnecessary. Thus, unnecessary data movement may occur even within the memory module.

In light of the first and second comparative examples that may cause unnecessary data movement as described above, the memory module 3 of the first embodiment that can reduce the processing cost for optimizing data placement will now be described.

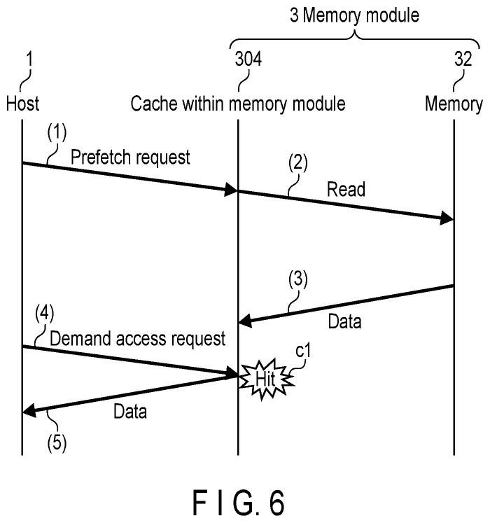

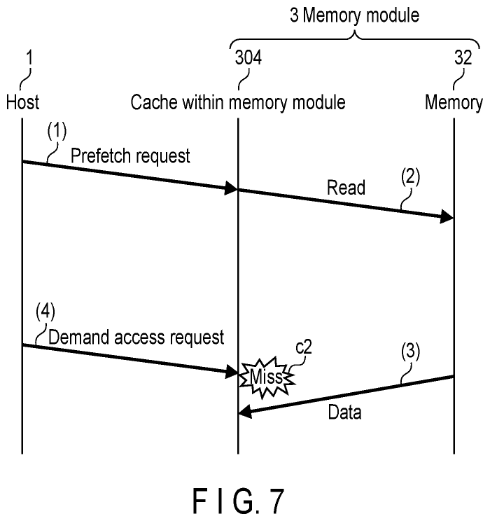

The memory module 3 of the first embodiment detects pages among a plurality of pages within the memory 32 for which prefetching is effective, and excludes those pages from or does not include those pages in the hot list, thereby suppressing unnecessary data movement from those pages by the data placement unit 12 of the host 1. With reference to FIG. 6 and FIG. 7, a method for detecting a page for which prefetching is effective in the memory module 3 of the first embodiment will be described.

FIG. 6 is a diagram showing a page for which prefetching is determined as effective.

When the memory module 3 receives a prefetch request from the host 1 (1), in a case where it is not a cache hit, it reads prefetch target data from the memory 32 (2). The memory module 3 stores the read prefetch target data in the cache 304 (3).

After the prefetch (2, 3) is completed, when a demand access request for the prefetch target data is received from the host 1 (4), a cache hit occurs (c1), and the memory module 3 transmits the data existing in the cache 304 to the host 1 (5).

Furthermore, in a case where the prefetch is completed in time for the demand access request, the memory module 3 determines that the target page is a page for which prefetching is effective. Completing the prefetch in time for the demand access request means that the prefetch is completed before the demand access request is received.

On the other hand, FIG. 7 is a diagram showing a page for which prefetching is determined as ineffective.

When the memory module 3 receives a prefetch request from the host 1 (1), in a case where it is not a cache hit, it performs prefetching of target data (2, 3).

If a demand access request for the prefetch target data is received from the host 1 before the prefetch is completed (4), a cache miss occurs (c2), and the memory module 3 waits for the prefetch to be completed, for example.

Then, in a case where the prefetch is not completed in time for the demand access request, the memory module 3 determines that the target page is not a page for which prefetching is effective. Not completing the prefetch in time for the demand access request means that the prefetch is not completed before the demand access request is received.

To detect pages for which prefetching is effective, in the memory module 3 of the first embodiment, the access monitoring unit 42 manages the cache hit count as one item of the access monitoring information as described with reference to FIG. 3.

The access monitoring unit 42 calculates a cache hit rate, which indicates the percentage of the target data existing in the cache 304 when a demand access request is received. The cache hit rate is calculated by dividing the cache hit count by the demand access count. In a case where the calculated cache hit rate is equal to or greater than a threshold for determining that prefetching is effective, the access monitoring unit 42 determines that the page is a page effective for prefetching. The access monitoring unit 42 excludes or does not include pages for which prefetching is effective detected through such procedures in the hot list to be transmitted to the data placement unit 12 of the host 1.

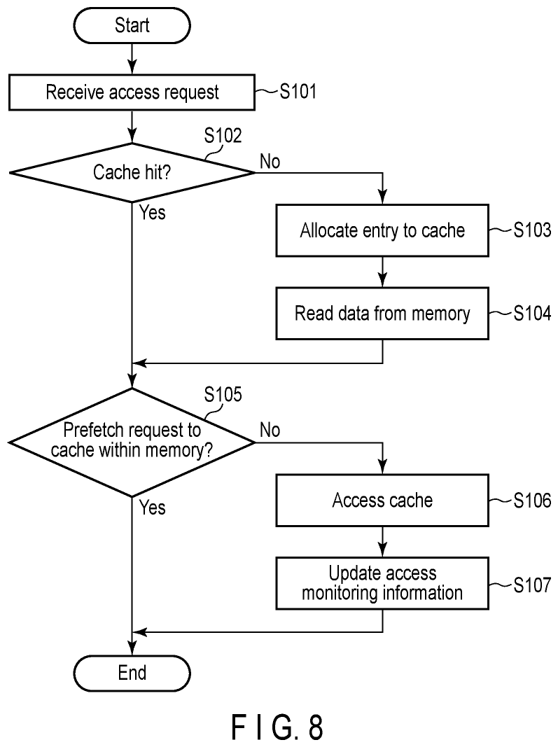

FIG. 8 is a flowchart showing a flow of memory access within the memory module 3.

The memory module 3 receives an access request (S101). This access request includes both a prefetch request and a demand access request. The memory module 3 determines whether or not access target data exists in the cache 304 (S102). In other words, it determines whether or not it is a cache hit.

In a case where it is not a cache hit (S102: No), i.e., in a case where it is a cache miss, the memory module 3 allocates an entry in the cache 304 for the access target data (S103). The memory module 3 reads the access target data from the memory 32 and stores it in the cache 304 (S104). In a case where it is a cache hit (S102: Yes), S103 and S104 are skipped.

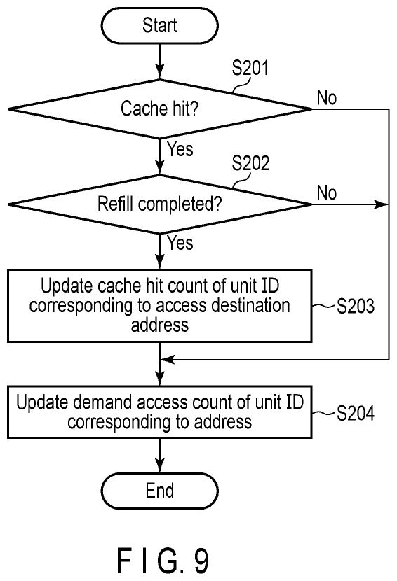

Next, the memory module 3 determines whether or not the access request received in S101 is a prefetch request (S105). In a case where it is not a prefetch request (S105: No), i.e., in a case where it is a demand access request, the memory module 3 accesses the cache 304, reads the access target data from the cache 304, and transmits it to the host 1 (S106). The memory module 3 updates the access monitoring information (S107) and ends the memory access processing. A procedure for updating the access monitoring information in S107 is described later with reference to FIG. 9.

In a case where the request is a prefetch request (S105: Yes), S106 and S107 are skipped, and the memory access processing is ended.

FIG. 9 is a flowchart showing a procedure for updating the access monitoring information.

The memory module 3 determines whether or not target data of the demand access request is a cache hit (S201). If it is a cache hit (S201: Yes), the memory module 3 then determines whether or not a refill has been completed (S202). The refill is completed when the status in the cache management information has changed from “Reading” to “Valid.”

In a case where the refill is completed (S202: Yes), the memory module 3 updates the cache hit count for the unit ID corresponding to an access destination address in the access monitoring information (S203). In S203, specifically, the cache hit count is incremented.

On the other hand, in a case where it is not the cache hit (S201: No) or in a case where it is the cache hit but the refill is incomplete (S202: No), the memory module 3 skips S203.

The memory module 3 updates the demand access count for the unit ID corresponding to the address in the access monitoring information (S204) and ends the access monitoring information updating process. Specifically, S204 also increments the demand access count.

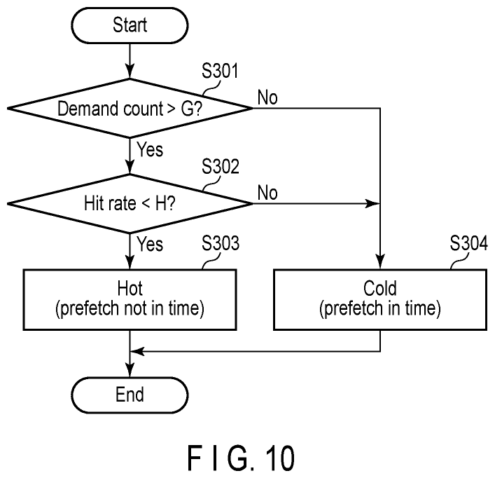

FIG. 10 is a flowchart showing a method for determining a state of each unit.

The memory module 3 determines whether or not the demand access count is greater than an access frequency threshold (G) for determining hot (S301). In a case where the demand access count is greater than the threshold G (S301: Yes), the memory module 3 then determines whether or not the hit rate is less than a cache hit rate threshold (H) that determines that prefetching is effective (S302).

In a case where the hit rate is less than the threshold H (S302: Yes), the memory module 3 determines that the determination target unit is hot (S303) and ends state determination processing.

On the other hand, in a case where the demand access count is less than or equal to the threshold G (S301: No), or the hit rate is greater than or equal to the threshold H (S302: No), the memory module 3 determines that the determination target unit is cold (S303) and ends the state determination processing. Here, the unit that is determined to be cold in S302 because the hit rate is equal to or greater than the threshold H is a unit that would normally be determined to be hot, but is deliberately determined to be cold because the latency of the memory 32 can be hidden by prefetching.

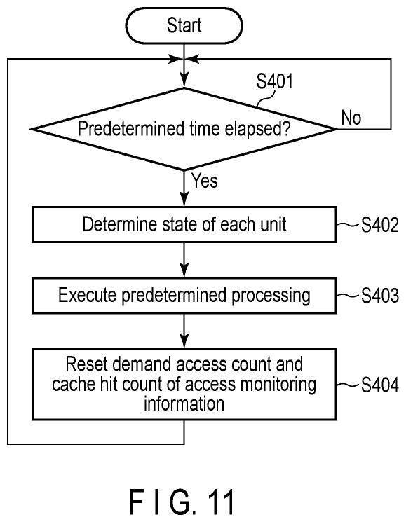

FIG. 11 is a flowchart showing a timing for executing particular processing related to data placement optimization. The particular processing is, for example, updating the hot list.

The memory module 3 determines whether or not a certain time has elapsed since the start of time measurement (S401). If the certain time has not elapsed (S401: No), the certain time is waited to elapse at S401.

In a case where the certain time has elapsed (S401: Yes), the memory module 3 determines the state of each unit as described with reference to FIG. 10 (S402). The memory module 3 performs the particular processing, such as updating the hot list, based on the result of S402 (S403).

Once the particular processing is complete, the memory module 3 resets the demand access count and the cache hit count of the access monitoring information (S404), returns to S401, and starts the time measurement again.

As described above, the memory module 3 of the first embodiment can reduce unnecessary data movement by the data placement unit 12 of the host 1 by determining whether or not it is a page for which prefetching is effective based on the demand access count and the cache hit rate, and by excluding hot data of the page for which prefetching is effective from the hot list.

That is, the memory module 3 of the first embodiment can reduce the processing cost for data placement optimization.

### Second Embodiment

Next, a second embodiment will be described. In the description of the second embodiment, the same reference symbols are used for the same components as in the first embodiment, and descriptions thereof will be omitted.

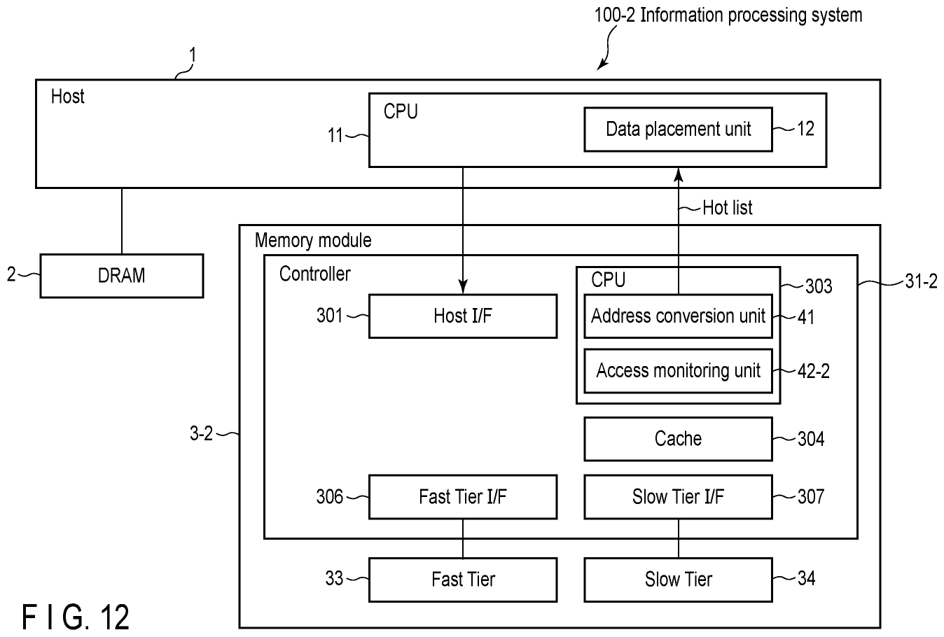

FIG. 12 is a diagram showing an example of a configuration of a memory module 3-2 of the second embodiment. FIG. 12 also shows an example in which the memory module 3-2 of the second embodiment is connected to a host 1 together with a DRAM 2 to configure an information processing system 100-2. The memory module 3-2 of the second embodiment has a controller 31-2 instead of the controller 31 of the memory module 3 of the first embodiment.

The memory module 3-2 of the second embodiment includes a Fast-Tier 33 which is a memory device with a high data transfer speed, and a Slow-Tier 34 which is a memory device with a low data transfer speed. For example, the Fast-Tier 33 is DRAM, and the Slow-Tier 34 is NAND flash memory. The DRAM installed in the memory module 3-2 as the Fast-Tier 33 has a larger latency than the DRAM 2 directly connected to the host 1 because the controller 31-2 is interposed between it and the host 1. That is, in the second embodiment, the host 1 forms a three-tier hierarchical memory system by combining the DRAM 2, the Fast-Tier 33, and the Slow-Tier 34. Therefore, in the second embodiment, unnecessary data movement from the Slow-Tier 34 to the Fast-Tier 33 may occur even within the memory module 3-2.

Additionally, the controller 31-2 of the second embodiment includes a Fast-Tier interface (I/F) 306 and a Slow-Tier interface (I/F) 307. The Fast-Tier I/F 306 is, for example, a Toggle DDR-compliant interface for transmitting and receiving data to and from the DRAM that is the Fast-Tier 33. The Slow-Tier I/F 307 is, for example, a Toggle DDR-compliant interface for transmitting and receiving data to and from the NAND flash memory that is the Slow-Tier 34.

In the memory module 3 of the first embodiment, it is determined whether or not it is a page for which prefetching is effective based on the demand access count and the cache hit rate. In contrast, the memory module 3-2 of the second embodiment determines whether or not it is a page for which prefetching is effective based on an interval time between a prefetch request and a demand access request (for prefetch target data).

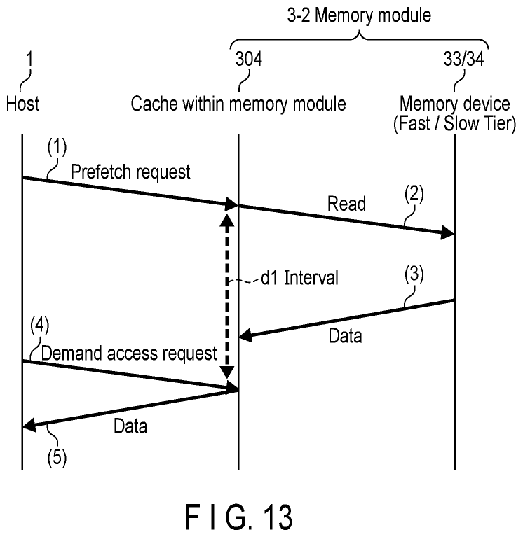

FIG. 13 is a diagram showing a method for determining whether or not it is a page for which prefetching is effective based on the interval time between a prefetch request and a demand access request in the memory module 3-2 of the second embodiment.

When the memory module 3-2 receives a prefetch request from the host 1 (1), in a case where it is not a cache hit, it reads prefetch target data from the Fast-Tier 33 or the Slow-Tier 34 (2). The memory module 3-2 stores the read prefetch target data in a cache 304 (3).

As described in the first embodiment, after the prefetch (2, 3) is completed, when a demand access request for the prefetch target data is received from the host 1 (4), the cache hit occurs, and the memory module 3 transmits data existing in the cache 304 to the host 1 (5). In this case, the prefetch can be considered effective.

Therefore, in the second embodiment, the memory module 3-2 determines that it is a page for which prefetching is effective in a case where the interval time between receiving the prefetch request and receiving the demand access request is longer than the latency of the Fast-Tier 33 or the Slow-Tier 34.

More specifically, for a page whose interval time is longer than the latency of the Slow-Tier 34, prefetching from the Slow-Tier 34 can be made in time; therefore, it is unnecessary to move data from the Slow-Tier 34 to the Fast-Tier 33 or the DRAM 2. In addition, for a page whose interval time is shorter than the latency of the Slow-Tier 34 but longer than the latency of the Fast-Tier 33, prefetching from the Fast-Tier 33 can be made in time; therefore, it is unnecessary to move data from the Fast-Tier 33 to the DRAM 2.

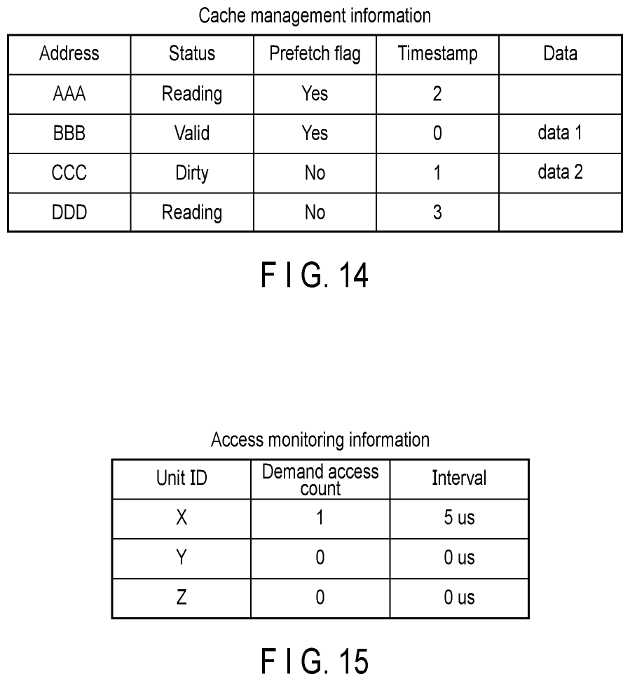

In order to determine whether or not it is a page for which prefetching is effective based on the interval time between the prefetch request and the demand access request, in the memory module 3-2 of the second embodiment, the controller 31-2 further stores a prefetch flag and a timestamp as items of the cache management information, as shown in FIG. 14.

The prefetch flag indicates whether or not the storage in the cache 304 was performed by prefetching. “Yes” indicates that it was performed by prefetching, and “No” indicates that it was not performed by prefetching. The timestamp indicates, for example, the order in which data was stored in the cache 304, and the elapsed time from which data was stored in the cache 304. Whether or not storage in the cache 304 was performed by prefetching may be distinguished by setting a specific magic number in the timestamp rather than by the flag.

In addition, in the memory module 3-2 of the second embodiment, in order to determine whether or not it is a page for which prefetching is effective based on the interval time between the prefetch request and the demand access request, an access monitoring unit 42-2 stores the interval instead of the cache hit count as an item of the access monitoring information, as shown in FIG. 15.

The interval is an average value of the interval time between the prefetch request and the demand access request. The interval is not limited to the average value and may, for example, be a most recent value.

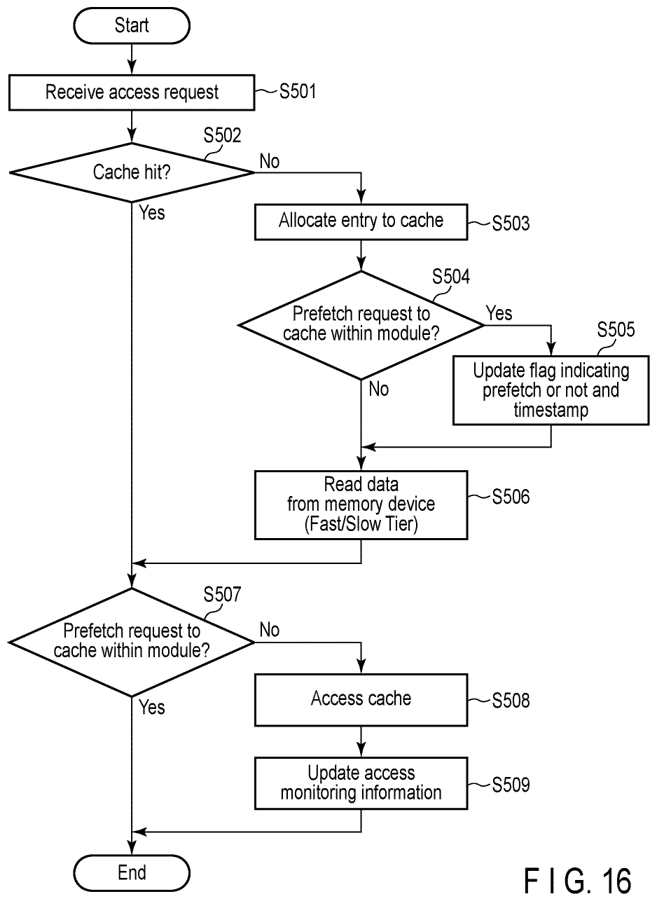

FIG. 16 is a flowchart showing a flow of memory access within the memory system of the second embodiment.

The memory module 3-2 receives an access request (S501). This access request includes a prefetch request and a demand access request. The memory module 3-2 determines whether or not access target data exists in the cache 304 (S502). In other words, it determines whether or not it is the cache hit.

In a case where it is determined that it is not the cache hit (S502: No), i.e., a cache miss, the memory module 3-2 allocates an entry in the cache 304 for the access target data (S503). Here, the memory module 3-2 determines whether or not the access request received in S501 is the prefetch request (S504). In a case where it is the prefetch request (S504: Yes), the memory module 3-2 updates the flag indicating whether or not it is the prefetch and the timestamp in the cache management information (S505).

In a case where it is not the prefetch request (S504: No), S505 is skipped. The memory module 3-2 reads the access target data from the Fast-Tier 33 or the Slow-Tier 34 and stores it in the cache 304 (S506).

Additionally, in a case where the cache hit is determined in S502 (S502: Yes), S503 to S506 are skipped.

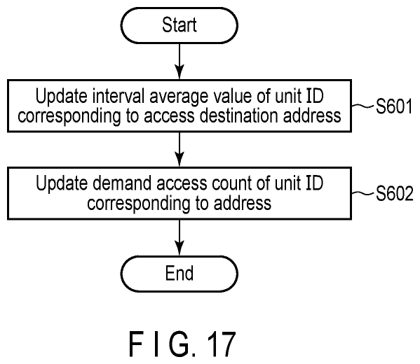

Next, the memory module 3-2 determines whether or not the access request received in S501 is the prefetch request (S507). In a case where it is not the prefetch request (S507: No), i.e., if it is the demand access request, the memory module 3-2 accesses the cache 304, reads the access target data from the cache 304, and transmits it to the host 1 (S508). The memory module 3-2 updates the access monitoring information (S509) and ends the memory access processing. The procedure for updating the access monitoring information in S509 is described later with reference to FIG. 17.

In a case where it is the prefetch request (S507: Yes), S508 and S509 are skipped, and the memory access processing is ended.

FIG. 17 is a flowchart showing a procedure for updating the access monitoring information.

The memory module 3-2 updates an average value of an interval for a unit ID corresponding to an access destination address in the access monitoring information (S601). In a case of a cache miss, or in a case of the cache hit but a refill is incomplete, for example, the interval time at that time is set to 0, and the average value is updated with 0.

The memory module 3-2 updates a demand access count for the unit ID corresponding to the address in the access monitoring information (S602) and ends the access monitoring information updating process. In S602, specifically, the demand access count is incremented.

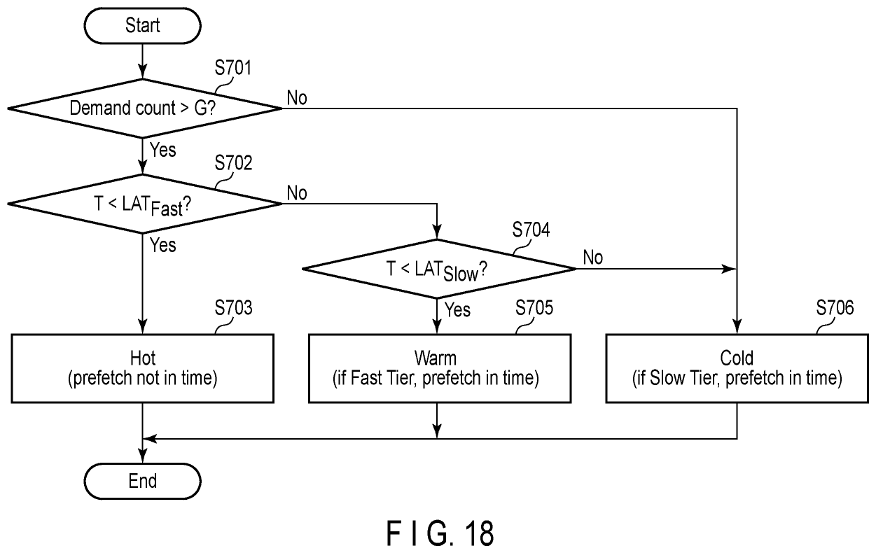

FIG. 18 is a flowchart showing a method for determining a state of each unit.

The memory module 3-2 determines whether or not the demand access count is greater than an access frequency threshold (G) for determining hot (S701). In a case where the demand access count is greater than the threshold G (S701: Yes), the memory module 3-2 then determines whether or not the interval (T) between the prefetch request and the demand access request is less than a latency (LAT_{Fast}) of the Fast-Tier 33 (S702).

In a case where the interval (T) is less than the latency LAT_{Fast} (S702: Yes), since it is not a page for which prefetching is effective, the memory module 3-2 determines that the determination target unit is hot (S703) for causing the data placement unit 12 of the host 1 to move the data of a page corresponding to this unit to the DRAM 2, and ends the state determination processing. This page is listed as hot data in a hot list.

In a case where the interval (T) is equal to or greater than the latency LAT_{Fast} (S702: No), the memory module 3-2 further determines whether or not the interval (T) is less than a latency (LAT_{Slow}) of the Slow-Tier 34 (S704). In a case where the interval (T) is less than the latency LAT_{Slow} (S704: Yes), since it is a page for which prefetching from the Fast-Tier 33 can be made in time, the memory module 3-2 determines that the determination target unit is warm (S705) for internally moving the data of a page corresponding to this unit to the Fast-Tier 33 if it exists in the Slow-Tier 34, and ends the state determination processing. This page is either deleted from the hot list or not added to the hot list.

In a case where the interval (T) is equal to or greater than the latency LAT_{Slow} (S704: No), since it is a page for which prefetching from the Slow-Tier 34 can be made in time, the memory module 3-2 determines that the determination target unit is cold (S706) for internally moving the data of this page to the Slow-Tier 34 as necessary if it exists in the Fast-Tier 33, and ends the state determination processing. A page corresponding to this unit is either deleted from the hot list or not added to the hot list.

In a case where the demand access count is less than or equal to the threshold G (S701: No), the memory module 3-2 determines that the determination target unit is truly cold (S706) and ends the state determination processing. In this case as well, if the page exists in the Fast-Tier 33, the memory module 3-2 internally moves the data of this page to the Slow-Tier 34 as necessary. This page is not originally listed in the hot list.

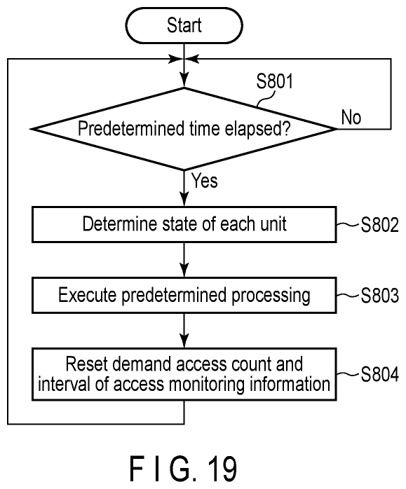

FIG. 19 is a flowchart showing a timing for executing particular processing related to data placement optimization. The particular processing in the second embodiment includes, for example, updating the hot list, moving data from the Slow-Tier 34 to the Fast-Tier 33, and moving data from the Fast-Tier 33 to the Slow-Tier 34.

The memory module 3-2 determines whether or not a certain time has elapsed since the start of time measurement (S801). If the certain time has not elapsed (S801: No), the certain time is waited to elapse at S801.

In a case where the certain time has elapsed (S801: Yes), the memory module 3-2 determines the state of each unit as described with reference to FIG. 18 (S802). The memory module 3-2 performs the particular processing based on the result of S802 (S803). Specifically, in a case where the page is determined to be hot, it is added to the hot list. In a case where the page is determined to be warm, if it exists in the Slow-Tier 34, it is moved to the Fast-Tier 33. In a case where the page is determined to be cold, if it exists in the Fast-Tier 33, it is moved to the Slow-Tier 34 as necessary. That is, the content of S803 differs from that of S403 in the first embodiment.

Once the particular processing is complete, the memory module 3-2 resets the demand access count and the interval of the access monitoring information (S804), returns to S801, and starts the time measurement again.

As described above, the memory module 3-2 of the second embodiment can reduce unnecessary data movement by the data placement unit 12 of the host 1 by determining whether or not it is a page for which prefetching is effective based on the interval time between the prefetch request and the demand access request, and by performing the particular processing that includes excluding hot data of the page for which prefetching is effective from the hot list. Note that, in a case of prioritizing the reduction of data movement, the process of moving pages determined to be cold from the Fast-Tier 33 to the Slow-Tier 34 does not have to be executed.

That is, the memory module 3-2 of the second embodiment can reduce the processing cost for data placement optimization.

### Third Embodiment

Next, a third embodiment will be described. In the description of the third embodiment, the same reference symbols are used for the same components as in the first and second embodiments, and descriptions thereof will be omitted.

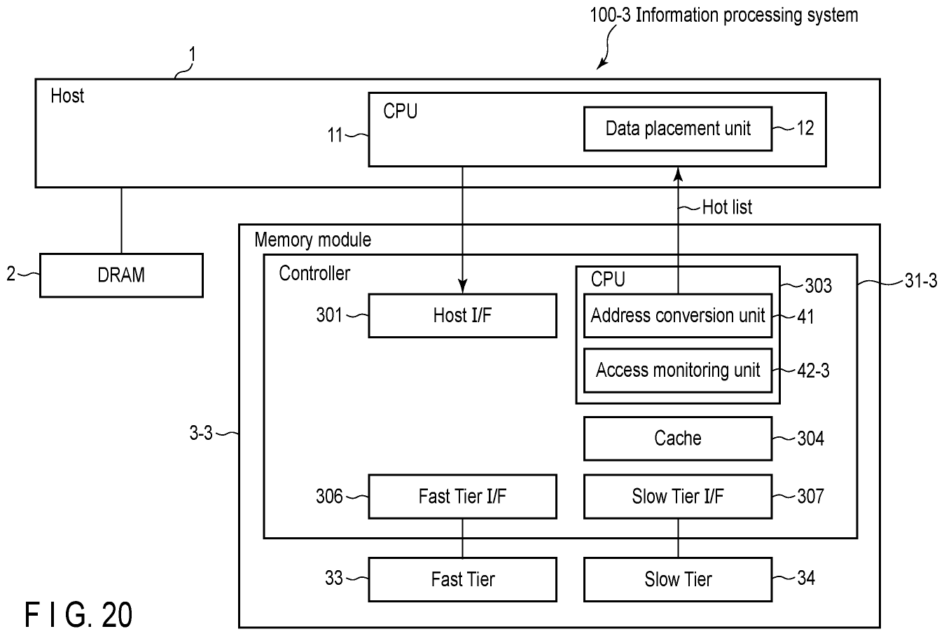

FIG. 20 shows a configuration example of a memory module 3-3 of the third embodiment. FIG. 20 also shows an example of the memory module 3-3 of the third embodiment connected to a host 1 together with a DRAM 2 to configure an information processing system 100-3. The memory module 3-3 of the third embodiment has a controller 31-3 instead of the controller 31 of the memory module 3 of the first embodiment.

In the first embodiment, the memory module 3 determines whether or not it is a page for which prefetching is effective based on the demand access count and the cache hit rate. In the second embodiment, the memory module 3-2 determines whether or not it is a page for which prefetching is effective based on the interval time between the prefetch request and the demand access request.

In the third embodiment, the memory module 3-3 determines whether or not it is a page for which prefetching is effective based on both (1) a demand access count and a cache hit rate, and (2) an interval time between a prefetch request and a demand access request.

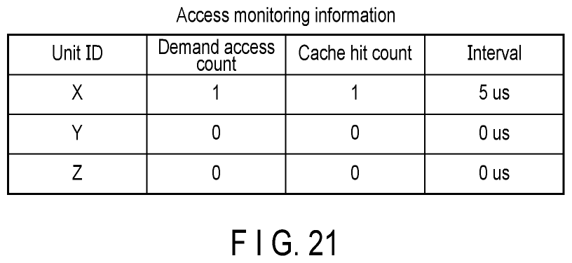

In the memory module 3-3 of the third embodiment, an access monitoring unit 42-3 stores both a cache hit count and an interval as items of the access monitoring information, as shown in FIG. 21. The cache management information is the same as in the second embodiment.

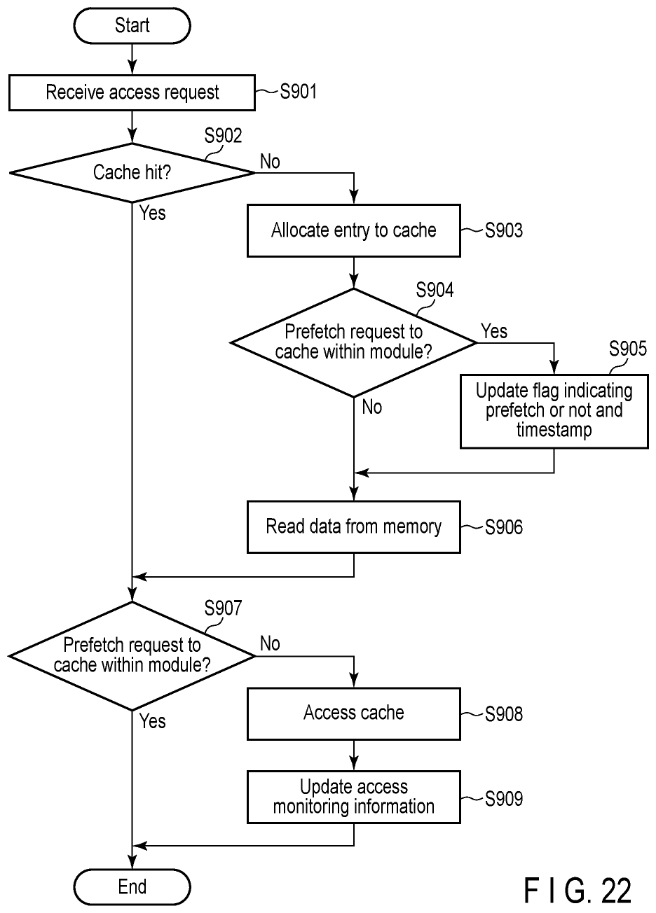

FIG. 22 is a flowchart showing a flow of memory access within the memory module 3-3 of the third embodiment.

The memory module 3-3 receives an access request (S901). This access request includes a prefetch request and a demand access request. The memory module 3-3 determines whether or not access target data exists in a cache 304 (S902). In other words, it determines whether or not it is a cache hit. In a case of the cache hit (S902: Yes), S903 to S906 are skipped, and the process proceeds to S907.

In a case where it is not the cache hit (S902: No), i.e., in a case where it is a cache miss, the memory module 3-3 allocates an entry in the cache 304 for the access target data (S903). Here, the memory module 3-3 determines whether or not the access request received in S901 is the prefetch request (S904). In a case of the prefetch request (S904: Yes), the memory module 3-3 updates a flag indicating whether or not it is a prefetch and a timestamp in the cache management information (S905). The memory module 3-3 reads the access target data from a memory 32 and stores it in the cache 304 (S906). In a case where it is not the prefetch request (S904: No), S905 is skipped.

Next, the memory module 3-3 determines whether or not the access request received in S901 is the prefetch request (S907). In a case of the prefetch request (S907: Yes), the memory module 3-3 skips S908 to S909 and ends the memory access processing.

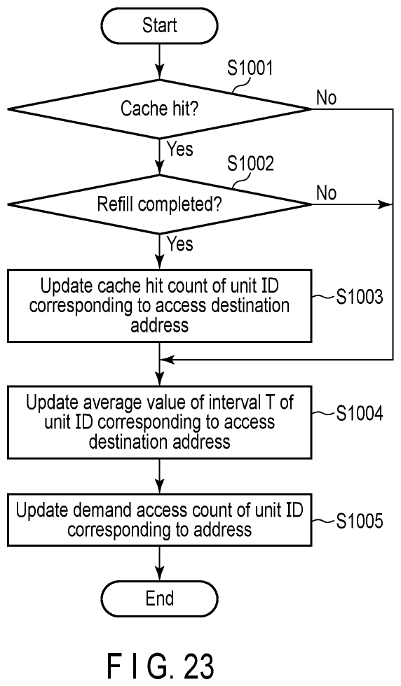

In a case where it is not the prefetch request (S907: No), i.e., in a case where it is the demand access request, the memory module 3-3 accesses the cache 304, reads access target data from the cache 304, and transmits it to the host 1 (S908). The memory module 3-3 updates the access monitoring information (S909) and ends the memory access processing. The procedure for updating the access monitoring information in S909 is described later with reference to FIG. 23.

FIG. 23 is a flowchart showing a procedure for updating the access monitoring information.

The memory module 3-3 determines whether or not target data of the demand access request is the cache hit (S1001). If it is the cache hit (S1001: Yes), the memory module 3-3 then determines whether or not a refill has been completed (S1002). As described in the first embodiment, the refill is completed when a status in the cache management information has been changed from “Reading” to “Valid.”

In a case where the refill is completed (S1002: Yes), the memory module 3-3 updates cache hit count for a unit ID corresponding to an access destination address in the access monitoring information (S1003). Specifically, the cache hit count is incremented.

In a case where it is not the cache hit (S1001: No) or in a case where it is the cache hit but the refill is incomplete (S1002: No), the memory module 3-3 skips S1003.

The memory module 3-3 updates an average value of the interval for the unit ID corresponding to the access destination address in the access monitoring information (S1004). In a case of the cache miss, or in a case of the cache hit but the refill is incomplete, for example, the interval time at that time is set to 0, and the average value is updated with 0.

The memory module 3-3 updates a demand access count for the unit ID corresponding to the address in the access monitoring information (S1005) and ends the access monitoring information updating process. In S1005, specifically, the demand access count is incremented.

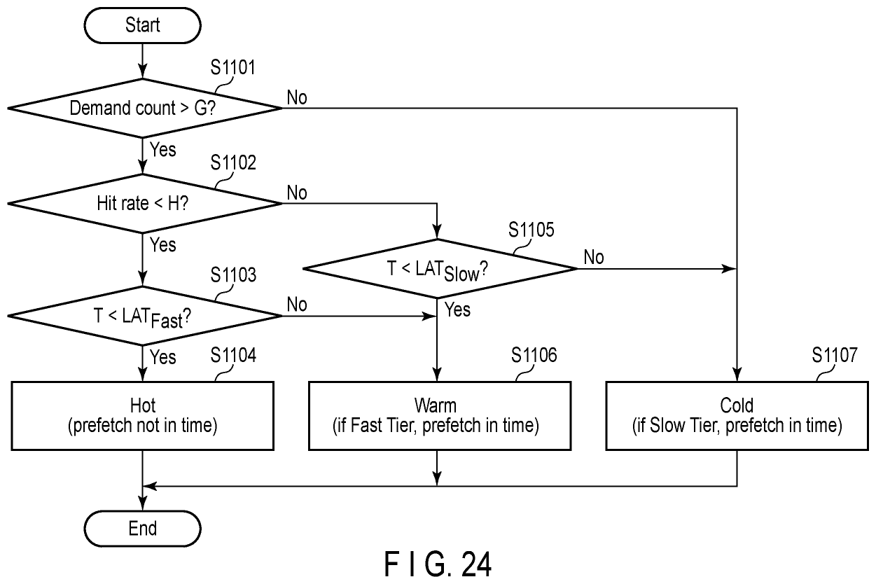

FIG. 24 is a flowchart showing a method for determining a state of each unit.

The memory module 3-3 determines whether or not the demand access count is greater than an access frequency threshold (G) for determining hot (S1101). In a case where the demand access count is greater than the threshold G (S1101: Yes), the memory module 3-3 then determines whether or not the hit rate is less than a cache hit rate threshold (H) that determines that prefetching is effective (S1102).

In a case where the hit rate is less than the threshold H (S1102: Yes), the memory module 3-3 then determines whether or not the interval (T) between the prefetch request and the demand access request is less than a latency (LAT_{Fast}) of a Fast-Tier 33 (S1103). In a case where the interval (T) is less than the latency LAT_{Fast} (S1103: Yes), it is not a page for which prefetching is effective; therefore, the memory module 3-3 determines that the determination target unit is hot (S1104) for causing the data placement unit 12 of the host 1 to move data of a page corresponding to this unit to the DRAM 2, and ends the state determination processing. This page is listed as hot in a hot list.

On the other hand, in a case where the interval (T) is equal to or greater than the latency LAT_{Fast} (S1103: No), since it is a page for which prefetching from the Fast-Tier 33 can be made in time, the memory module 3-3 determines that the determination target unit is warm (S1106) for internally moving the data of this page to the Fast-Tier 33 if it exists in a Slow-Tier 34, and ends the state determination processing. A page corresponding to this unit is either deleted from the hot list or not added to the hot list.

In a case where the hit rate is equal to or greater than the threshold H (S1102: No), the memory module 3-3 then determines whether or not the interval (T) between the prefetch request and the demand access request is less than a latency (LAT_{Slow}) of the Slow-Tier 34 (S1105). In a case where the interval (T) is less than the latency LAT_{Slow} (S1105: Yes), since it is a page for which prefetching from the Slow-Tier 34 cannot be made in time, the memory module 3-3 determines that the determination target unit is warm (S1106) for internally moving data of this page to the Fast-Tier 33 if it exists in the Slow-Tier 34, and ends the state determination processing. A page corresponding to this unit is either deleted from the hot list or not added to the hot list.

In a case where the interval (T) is equal to or greater than the latency LAT_{Slow} (S1105: No), since it is a page for which prefetching from the Slow-Tier 34 can be made in time, the memory module 3-3 determines the determination target unit is cold (S1107) for internally moving data of this page to the Slow-Tier 34 if it exists in the Fast-Tier 33, and ends the state determination processing. A page corresponding to this unit is either deleted from the hot list or not added to the hot list.

In a case where the demand access count is less than or equal to the threshold G (S1101: No), the memory module 3-3 determines that the determination target unit is truly cold (S1107) and ends the state determination processing. In this case as well, if the page exists in the Fast-Tier 33, the memory module 3-3 internally moves data of a page corresponding to this unit to the Slow-Tier 34 as necessary. This page is not originally listed in the hot list.

Note that a flowchart showing a timing for executing particular processing related to data placement optimization is the same as that of the second embodiment described with reference to FIG. 19.

As described above, the memory module 3-3 of the third embodiment can reduce unnecessary data movement by the data placement unit 12 of the host 1 by determining whether or not it is a page for which prefetching is effective based on both (1) the demand access count and the cache hit rate, and (2) the interval time between the prefetch request and the demand access request, and by performing the particular processing that includes excluding hot data of the page for which prefetching is effective from the hot list.

That is, the memory module 3-3 of the third embodiment can reduce the processing cost for data placement optimization.

### Fourth Embodiment

Next, a fourth embodiment will be described. In the description of the fourth embodiment, the same reference symbols are used for the same components as in the first to third embodiments, and descriptions thereof will be omitted.

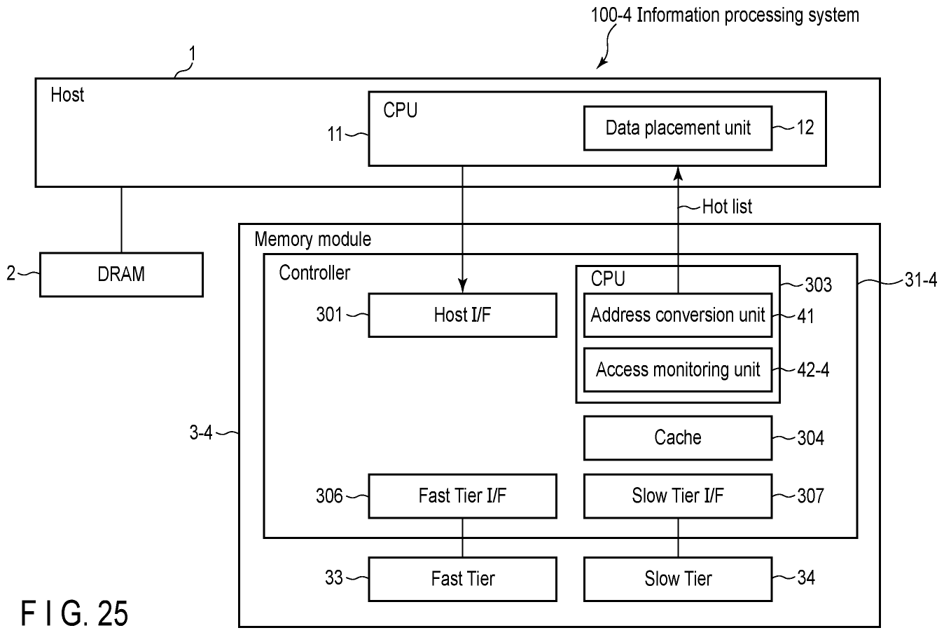

FIG. 25 is a diagram showing an example of a configuration of a memory module 3-4 of the fourth embodiment. FIG. 25 also shows an example in which the memory module 3-4 of the fourth embodiment is connected to a host 1 together with a DRAM 2 to configure an information processing system 100-4. The memory module 3-4 of the fourth embodiment has a controller 31-4 instead of the controller 31 of the memory module 3 of the first embodiment.

In the memory module 3-2 of the second embodiment, it is determined whether or not it is a page for which prefetching is effective based on the interval time between the prefetch request to the demand access request (for prefetch target data).

Here, for example, a case is considered where the host 1 specifies data in 64-byte units in the prefetch request or the demand access request, while the controller 31-4 of the memory module 3-4 reads data from a Fast-Tier 33 or a Slow-Tier 34 in 4-Kbyte units. In this case, data (4-Kbytes-64-bytes) other than the target data (64-bytes) of the prefetch request or the demand access request is also stored in a cache 304. The storage of this (4-Kbytes-64-bytes) data in the cache 304 can also be regarded as prefetching to the cache 304. Also, a prefetch request to load data into a cache built into a CPU 11 of the host 1 can be regarded as prefetching to the cache 304 in the same manner as the demand access request.

Therefore, the memory module 3-4 of the fourth embodiment manages an interval time between storage of data in the cache 304 and reception of a demand access request for the data stored in the cache 304 in response to a prefetch request or a demand access request, not limited to the target data of the prefetch request, and determines whether or not prefetching is effective based on this interval time.

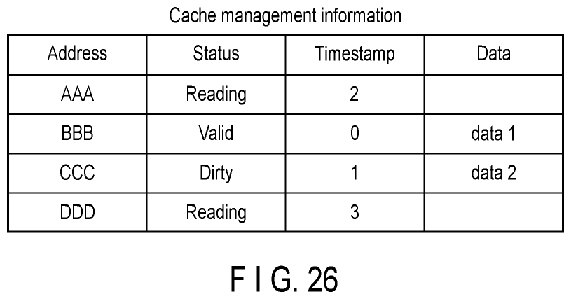

For this purpose, in the memory module 3-4 of the fourth embodiment, the controller 31-4 does not store a prefetch flag as an item of the cache management information, as shown in FIG. 26 (compared with the cache management information of the memory module 3-2 of the second embodiment described with reference to FIG. 14). The access monitoring information managed by an access monitoring unit 42-4 is the same as that in the second embodiment (see FIG. 15).

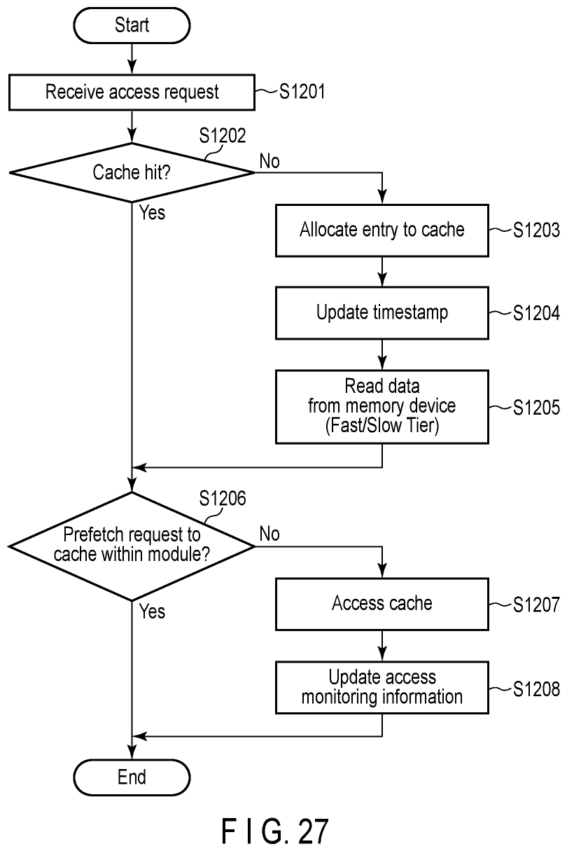

FIG. 27 is a flowchart showing a flow of memory access within the memory system of the fourth embodiment.

The memory module 3-4 receives an access request (S1201). This access request includes a prefetch request and a demand access request. The memory module 3-4 determines whether or not access target data exists in the cache 304 (S1202). In other words, it determines whether or not it is a cache hit.

In a case where it is determined that it is not the cache hit (S1202: No), i.e., a cache miss, the memory module 3-4 allocates an entry in the cache 304 for the access target data (S1203). The memory module 3-4 updates a timestamp in the cache management information (S1204). The memory module 3-4 reads the access target data from a Fast-Tier 33 or a Slow-Tier 34 and stores it in the cache 304 (S1205). In a case where it is determined to be the cache hit (S1202: Yes), S1203 to S1205 are skipped.

Next, the memory module 3-4 determines whether or not the access request received in S1201 is the prefetch request (S1206). In a case where it is not the prefetch request (S1206: No), i.e., in a case where it is the demand access request, the memory module 3-4 accesses the cache 304, reads the access target data from the cache 304, and transmits it to the host 1 (S1207). The memory module 3-4 updates the access monitoring information (S1208) and ends the memory access processing. The procedure for updating the access monitoring information in S1208 is the same as that of the second embodiment described with reference to FIG. 17.

In a case where it is the prefetch request (S1206: Yes), S1207 and S1208 are skipped, and the memory access processing is ended.

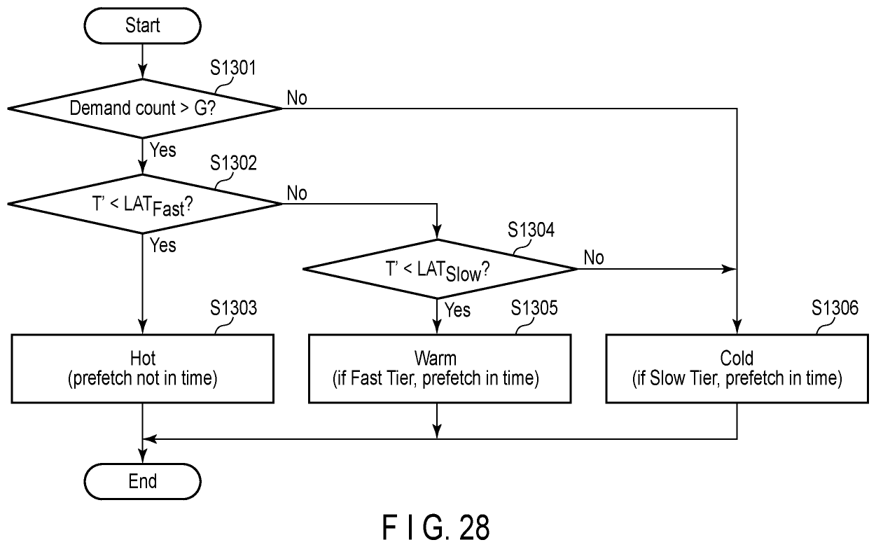

FIG. 28 is a flowchart showing a method for determining a state of each unit.

The memory module 3-4 determines whether or not a demand access count is greater than an access frequency threshold (G) for determining hot (S1301). In a case where the demand access count is greater than the threshold G (S1301: Yes), the memory module 3-4 then determines whether or not the interval (T′) between the storage of data in the cache 304 and reception of the demand access request is less than a latency (LAT_{Fast}) of the Fast-Tier 33 (S1302).

In a case where the interval (T′) is less than the latency LAT_{Fast} (S1302: Yes), the memory module 3-4 determines that the determination target unit is hot (S1303) and ends the state determination processing. When the unit is determined to be hot, a page corresponding to this unit is listed in a hot list, and data is moved to the DRAM 2 by a data placement unit 12 of the host 1.

In a case where the interval (T′) is equal to or greater than the latency LAT_{Fast} (S1302: No), the memory module 3-4 further determines whether or not the interval (T′) is less than a latency (LAT_{Slow}) of the Slow-Tier 34 (S1304). In a case where the interval (T′) is less than the latency LAT_{Slow} (S1304: Yes), the memory module 3-4 determines that the determination target unit is warm (S1305) and ends the state determination processing. When the unit is determined to be warm, a page corresponding to this unit is either deleted from the hot list or not added to the hot list, and data is internally moved to the Fast-Tier 33 as necessary.

In a case where the interval (T′) is equal to or greater than the latency LAT_{Slow} (S1304: No), the memory module 3-4 determines that the determination target unit is cold (S1306) and ends the state determination processing. When the unit is determined to be cold, a page corresponding to this unit is either deleted from the hot list or not added to the hot list, and data is internally moved to the Slow-Tier 34 as necessary.

In a case where the demand access count is equal to or less than the threshold G (S1301: No), the memory module 3-4 determines that the determination target unit is truly cold (S1306) and ends the state determination processing. In this case as well, the memory module 3-4 internally moves the page to the Slow-Tier 34 as necessary.

Note that the timing for executing particular processing related to data placement optimization is the same as that of the second embodiment described with reference to FIG. 19.

As described above, the memory module 3-4 of the fourth embodiment can reduce unnecessary data movement by the data placement unit 12 of the host 1 by determining whether or not it is a page for which prefetching is effective based on the interval time between when data stored in the cache 304 was stored in the cache 304 and when a demand access request is received, and by performing the particular processing that includes excluding hot data of the page for which prefetching is effective from the hot list.

That is, the memory module 3-4 of the fourth embodiment can reduce the processing cost for data placement optimization.

### Fifth Embodiment

Next, a fifth embodiment will be described. In the description of the fifth embodiment, the same reference symbols are used for the same components as in the first to fourth embodiments, and descriptions thereof will be omitted.

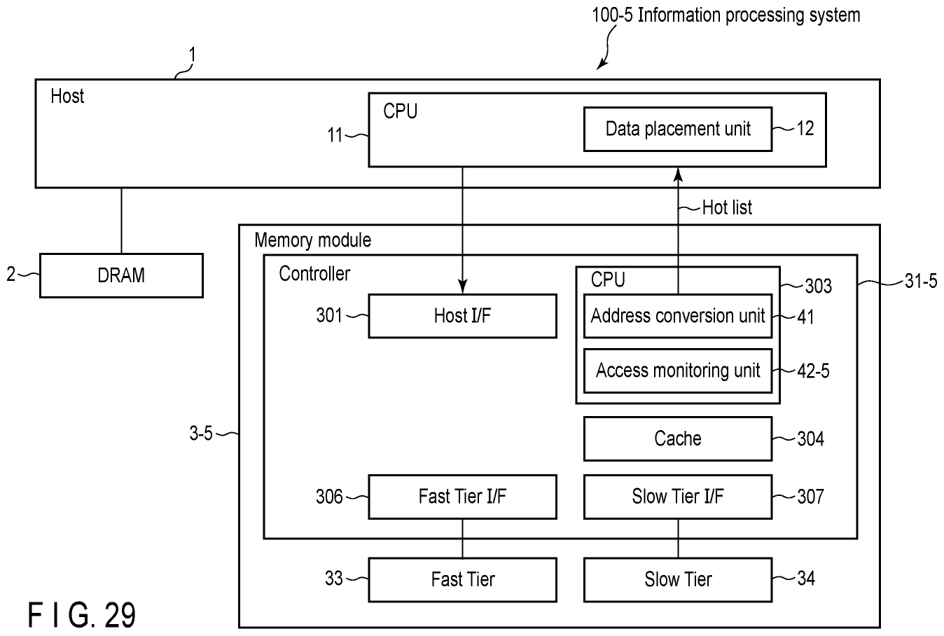

FIG. 29 is a diagram showing an example of a configuration of a memory module 3-5 of the fifth embodiment. FIG. 29 also shows an example in which the memory module 3-5 of the fifth embodiment is connected to a host 1 together with a DRAM 2 to configure an information processing system 100-5. The memory module 3-5 of the fifth embodiment has a controller 31-5 instead of the controller 31 of the memory module 3 of the first embodiment.

In the fourth embodiment, the memory module 3-4 determines whether or not it is a page for which prefetching is effective based on the interval time between storage of data in the cache 304 and reception of a demand access request for the data stored in the cache 304. In contrast, the memory module 3-5 of the fifth embodiment further determines whether or not it is a page for which prefetching is effective based on a cache hit rate.

The cache management information in the memory module 3-5 of the fifth embodiment is the same as that of the fourth embodiment described with reference to FIG. 26, and the access monitoring information is the same as that of the third embodiment described with reference to FIG. 21.

Furthermore, a flow of memory access within the memory module 3-5 of the fifth embodiment is the same as that of the fourth embodiment described with reference to FIG. 27, and a procedure for updating the access monitoring information in the memory module 3-5 of the fifth embodiment is the same as that of the third embodiment described with reference to FIG. 23.

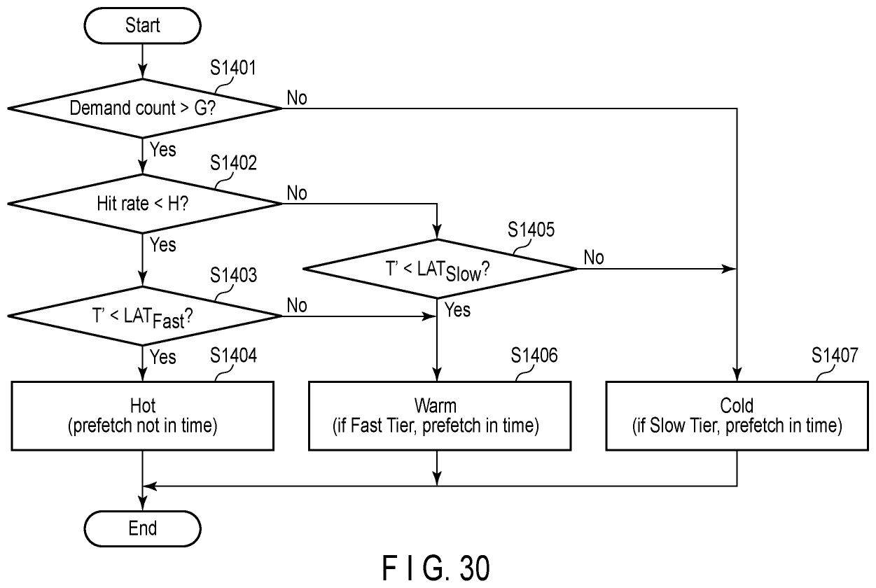

FIG. 30 is a flowchart showing a method for determining a state of each unit.

The memory module 3-5 determines whether or not a demand access count is greater than an access frequency threshold (G) for determining hot (S1401). In a case where the demand access count is greater than the threshold G (S1401: Yes), the memory module 3-5 then determines whether or not a hit rate is less than a cache hit rate threshold (H) that determines that prefetching is effective (S1402).

In a case where the hit rate is less than the threshold H (S1402: Yes), the memory module 3-5 then determines whether or not an interval (T′) between the storage of data in the cache 304 and the reception of the demand access request is less than a latency (LAT_{Fast}) of a Fast-Tier 33 (S1403).

In a case where the interval (T′) is less than the latency LAT_{Fast} (S1403: Yes), the memory module 3-5 determines that the determination target unit is hot (S1404) and ends the state determination processing. When the unit is determined to be hot, a page corresponding to this unit is listed in a hot list, and data is moved to the DRAM 2 by a data placement unit 12 of the host 1.

In a case where the interval (T′) is equal to or greater than the latency LAT_{Fast} (S1403: No), the memory module 3-5 determines that the determination target unit is warm (S1406) and ends the state determination processing. When the unit is determined to be warm, a page corresponding to this unit is either deleted from the hot list or not added to the hot list, and data is internally moved to the Fast-Tier 33 as necessary.

In a case where the hit rate is equal to or greater than the threshold H (S1402: No), the memory module 3-5 further determines whether or not the interval (T′) is less than a latency (LAT_{Slow}) of a Slow-Tier 34 (S1405). In a case where the interval (T′) is less than the latency LAT_{Slow} (S1405: Yes), the memory module 3-5 determines that the determination target unit is warm (S1406) and ends the state determination processing. As described above, when the unit is determined to be warm, a page corresponding to this unit is either deleted from the hot list or not added to the hot list, and data is internally moved to the Fast-Tier 33 as necessary.

In a case where the interval (T′) is equal to or greater than the latency LAT_{Slow} (S1405: No), the memory module 3-5 determines that the determination target unit is cold (S1407) and ends the state determination processing. When the unit is determined to be cold, a page corresponding to this unit is either deleted from the hot list or not added to the hot list, and data is internally moved to the Slow-Tier 34 as necessary.

In a case where the demand access count is equal to or less than the threshold G (S1401: No), the memory module 3-5 determines that the determination target unit is truly cold (S1407) and ends the state determination processing. In this case as well, the memory module 3-5 internally moves data to the Slow-Tier 34 as necessary.

Note that the timing for executing the particular processing related to data placement optimization is the same as that of the second embodiment described with reference to FIG. 19.

As described above, the memory module 3-5 of the fifth embodiment can reduce unnecessary data movement by the data placement unit 12 of the host 1 by determining whether or not it is a page for which prefetching is effective based on both the demand access count and the cache hit rate, and the interval time between when data stored in the cache 304 was stored in the cache 304 and when a demand access request is received, and by performing the particular processing that includes excluding hot data of the page for which prefetching is effective from the hot list.

That is, the memory module 3-5 of the fifth embodiment can reduce the processing cost for data placement optimization.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
one or more memories; and
a controller capable of communicating with a host, configured to control the memory, and including a cache for temporarily storing data read from the memory, wherein
the controller is configured to:
read, after receiving a prefetch request from the host, prefetch target data from the memory and store the read data in the cache;
manage first information related to whether or not the prefetch is effective for each data read from the memory in response to a demand access request from the host; and
perform first processing related to data layout optimization of the data read from the memory based on the first information.

2. The memory system of claim 1, wherein
the controller is further configured to manage, as the first information, a cache hit rate indicating a percentage of the target data existing in the cache when the demand access request is received.

3. The memory system of claim 2, wherein
the controller is further configured to:
manage a hot list configured to store identifiers of hot data whose access frequency over a recent fixed period is equal to or greater than a first threshold; and
perform, as the first processing, processing of excluding from the hot list data whose cache hit rate is equal to or greater than a second threshold from among data to be determined as the hot data.

4. The memory system of claim 2, wherein
the one or more memories include a first memory and a second memory whose data transfer speed is slower than that of the first memory, and
the controller is further configured to perform, as the first processing, processing of placing data whose cache hit rate is equal to or greater than a second threshold in the first memory from among data to be determined as hot data whose access frequency over a recent fixed period is equal to or greater than a first threshold.

5. The memory system of claim 1, wherein
the controller is further configured to manage, as the first information, an interval time between reception of the prefetch request and reception of a demand access request for the prefetch target data.

6. The memory system of claim 5, wherein
the one or more memories include a first memory and a second memory whose data transfer speed is slower than that of the first memory, and
the controller is further configured to:
manage a hot list configured to store identifiers of hot data whose access frequency over a recent fixed period is equal to or greater than a first threshold; and
perform, as the first processing, processing of excluding from the hot list data whose interval time is equal to or longer than a data read time of the first memory from among data to be determined as the hot data.

7. The memory system of claim 6, wherein
the controller is further configured to:
place, in the second memory, data whose interval time is equal to or longer than the data read time of the second memory from among data to be excluded from the hot list; and
place, in the first memory, data whose interval time is shorter than the data read time of the second memory from among data to be excluded from the hot list.

8. The memory system of claim 1, wherein
the one or more memories include a first memory and a second memory whose data transfer speed is slower than that of the first memory, and
the controller is further configured to:
manage a hot list configured to store identifiers of hot data whose access frequency over a recent fixed period is equal to or greater than a first threshold;
manage, as the first information, a cache hit rate indicating a percentage of the target data existing in the cache when the demand access request is received and an interval time between reception of the prefetch request and reception of a demand access request for the prefetch target data.

9. The memory system of claim 8, wherein
the one or more memories include a first memory and a second memory whose data transfer speed is slower than that of the first memory, and
the controller is further configured to perform, as the first processing,
(1) excluding from the hot list data whose cache hit rate is less than a second threshold and whose interval time is equal to or longer than a data read time of the first memory from among data to be determined as the hot data, and placing the data in the first memory,
(2) placing in the first memory data whose cache hit rate is equal to or greater than the second threshold and whose interval time is shorter than a data read time of the second memory, and
(3) placing in the second memory data whose cache hit rate is equal to or greater than the second threshold and whose interval time is equal to or longer than the data read time of the second memory.

10. The memory system of claim 1, wherein
the controller is further configured to manage, as the first information, an interval time between storage of data in the cache and reception of a demand access request for the data stored in the cache.

11. The memory system of claim 10, wherein
the controller is further configured to:
receive a prefetch request or a demand access request targeting data in units of N (where N is an integer of one or more) bytes from the host; and
perform reading data from the memory in units of N×M (where M is an integer of two or more) bytes, and wherein
data read from the memory and stored in the cache other than the prefetch target data includes (N×M−N) bytes of data read from the memory and stored in the cache together with target data of the prefetch request or the demand access request.

12. The memory system of claim 10, wherein
the controller is further configured to manage, as the first information, a cache hit rate indicating a percentage of the target data existing in the cache when the demand access request is received.

13. A control device capable of communicating with a host and controlling one or more memories, and including a cache for temporarily storing data read from the memories,
read, after receiving a prefetch request from the host, prefetch target data from the memory and store the read data in the cache,
manage first information related to whether or not the prefetch is effective for each data read from the memory in response to a demand access request from the host; and
perform first processing related to data placement optimization of the data read from the memory based on the first information.

14. The control device of claim 13, wherein
the control device is further configured to manage, as the first information, a cache hit rate indicating a percentage of the target data existing in the cache when the demand access request is received.

15. The control device of claim 13, wherein
the control device is further configured to manage, as the first information, an interval time between reception of the prefetch request and reception of a demand access request for the prefetch target data.

16. The control device of claim 13, wherein
the one or more memories include a first memory and a second memory whose data transfer speed is slower than that of the first memory, and
the control device is further configured to:
manage a hot list configured to store identifiers of hot data whose access frequency over a recent fixed period is equal to or greater than a first threshold;
manage, as the first information, a cache hit rate indicating a percentage of the target data existing in the cache when the demand access request is received and an interval time between reception of the prefetch request and reception of a demand access request for the prefetch target data; and
perform, as the first processing,
(1) excluding from the hot list data whose cache hit rate is less than a second threshold and whose interval time is equal to or longer than a data read time of the first memory from among data to be determined as the hot data, and placing the data in the first memory,
(2) placing in the first memory data whose cache hit rate is equal to or greater than the second threshold and whose interval time is shorter than a data read time of the second memory, and
(3) placing in the second memory data whose cache hit rate is equal to or greater than the second threshold and whose interval time is equal to or longer than the data read time of the second memory.

17. A control method of a control device capable of communicating with a host, controlling one or more memories, and including a cache for temporarily storing data read from the memory, the method comprising:
reading, after receiving a prefetch request from the host, prefetch target data from the memory and storing the read data in the cache;
managing first information related to whether or not the prefetch is effective for each data read from the memory by a demand access request from the host; and
performing first processing related to data placement optimization of the data read from the memory based on the first information.

18. The control method of claim 17, further comprising:
Managing, as the first information, a cache hit rate indicating a percentage of the target data existing in the cache when the demand access request is received.

19. The control method of claim 17, further comprising:
managing, as the first information, an interval time between reception of the prefetch request and reception of a demand access request for the prefetch target data.

20. The control method of claim 17, wherein
the one or more memories include a first memory and a second memory whose data transfer speed is slower than that of the first memory, and
the method further comprises:
managing a hot list configured to store identifiers of hot data whose access frequency over a recent fixed period is equal to or greater than a first threshold;
managing, as the first information, a cache hit rate indicating a percentage of the target data existing in the cache when the demand access request is received and an interval time between reception of the prefetch request and reception of a demand access request for the prefetch target data; and
performing, as the first processing,
(1) excluding from the hot list data whose cache hit rate is less than a second threshold and whose interval time is equal to or longer than a data read time of the first memory from among data to be determined as the hot data, and placing the data in the first memory,
(2) placing in the first memory data whose cache hit rate is equal to or greater than the second threshold and whose interval time is shorter than a data read time of the second memory, and
(3) placing in the second memory data whose cache hit rate is equal to or greater than the second threshold and whose interval time is equal to or longer than the data read time of the second memory.
